(19) United States
(12) Patent Application Publication
(10) Pub. No.: US 2024/0161120 A1
(43) Pub. Date: May 16, 2024

(54) Generating Synthetic Representatives in the Metaverse

(71) Applicant: STATE FARM MUTUAL AUTOMOBILE INSURANCE COMPANY, Bloomington, IL (US)

(72) Inventors: Edward W. Breitweiser, Bloomington, IL (US); Brian N. Harvey, Bloomington, IL (US); Joseph Robert Brannan, Bloomington, IL (US); Joseph Harr, Bloomington, IL (US)

(21) Appl. No.: 18/114,811

(22) Filed: Feb. 27, 2023

Related U.S. Application Data
(60) Provisional application No. 63/425,190, filed on Nov. 14, 2022.

(51) Int. Cl. G06Q 30/015; G06N 3/006; G06N 20/00

(52) U.S. Cl. CPC G06Q 30/015; G06N 3/006; G06N 20/00

(57) ABSTRACT

Systems and methods for generating a virtual synthetic representative based upon a person or user are disclosed. Personal data associated with a person is collected, including personal data regarding a past communication of the person. One or more attributes indicative of personal mannerisms of the individual person are identified from the personal data. A synthetic virtual representative profile is then created from the identified personal mannerisms, and a synthetic virtual representative is virtually constructed based upon the virtual representative profile. The synthetic representative construction including a visual representation of the representative in a virtual environment.

### CROSS-REFERENCE TO RELATED APPLICATIONS

This application claims the benefit of U.S. Provisional Application No. 63/425,190, filed Nov. 14, 2022, which is incorporated by reference herein in its entirety.

### TECHNICAL FIELD

The present disclosure generally relates to systems and methods for generating virtual avatar representatives of individuals using real world data pertaining to the individuals.

### BACKGROUND

In commercial settings, conventional approaches to customer interactions (e.g., for collecting customer information and/or providing information to customers) may require a person to physically travel to a store, or call a representative which is another physical person that then responds or provides services. Due to physical constraints, some customers may have trouble traveling to or calling a representative, and therefore may be limited in obtaining information pertaining to a service. Additionally, conventional approaches to customer interactions may have various drawbacks, such as inefficient or ineffective relaying of information, as well as an inability to collect complete and/or accurate datasets. The present embodiments may overcome these and/or other deficiencies of conventional techniques.

### SUMMARY

The present embodiments may relate to, inter alia, the generation of synthetic virtual representatives of individual people in a virtual environment. The synthetic representatives may be visual and auditory representations of a person, such as an avatar of that person in a virtual landscape, room, etc.

In one aspect, a computer-implemented method for generating a virtual synthetic representative may be provided. The method may be implemented via one or more local or remote processors, transceivers, sensors, servers, memory units, mobile devices, wearables, smart watches, smart glasses, augmented reality glasses, virtual reality headsets, and/or electric or electronic components. In one instance, the method may include, via one or more local or remote processors: (1) collecting personal data regarding past communications of an individual person; (2) identifying from the personal data one or more attributes indicative of personal mannerisms of the individual person; (3) creating a synthetic representative profile indicative of the personal mannerisms of the person from the one or more attributes; and/or (4) virtually constructing a synthetic representative from the synthetic representative profile, the synthetic representative including a visual representation in a virtual environment. The method may include additional, fewer, or alternate actions, including those discussed elsewhere herein.

For instance, the method may further include constructing the synthetic representative by training a machine learning algorithm using the collected personal data to generate virtual representations that mimic the personal mannerisms. The personal data may include data indicative of one or more observable characteristics of the person such as hair color, height, eye color, mannerisms, vocal tone, speech patterns, etc. Additionally, the personal data may include any of recordings, video, images, biometric data, audio, etc. To collect the personal data, a processor may perform scraping of one or more social media accounts to collect the personal data from the one or more social media accounts.

The processor may construct the synthetic representative by generating a three-dimensional avatar of the person from images of the person, and/or images associated with a social media account. The identified attributes may include one or more of a race, ethnicity, sex, gender, hair style, hair, eyewear, preferred clothing type(s) or fashion, preferred footwear or shoes, lexicon, speech pattern, intonation, physical feature, fashion style, personal interest, hobby, etc.

In certain examples, the individual person may be an insurance agent and the synthetic representative may then be a synthetic agent, and the synthetic representative profile may be an agent profile. In other examples, the individual person may be a customer and the synthetic representative may then be a synthetic customer, and the synthetic representative profile may be a customer profile.

Systems or computer-readable media storing instructions for implementing all or part of the methods described above may also be provided in some aspects. Systems for implementing such methods may include one or more of the following: one or more local or remote processors, transceivers, sensors, servers, memory units, mobile devices, wearables, smart watches, smart glasses, augmented reality glasses, virtual reality headsets, and/or electric or electronic components. In one instance, the systems may include one or more processors, and one or more non-transitory memories storing non-transitory computer-executable instructions that, when executed via the one or more processors, cause the computing system to: (1) collect personal data regarding past communications of an individual person; (2) identify from the personal data, one or more attributes indicative of personal mannerisms of the individual person; (3) create, a synthetic representative profile indicative of the personal mannerisms of the person from the one or more attributes; and/or (4) virtually construct a synthetic representative from the synthetic representative profile, the synthetic representative including a visual representation in a virtual environment. Such program memories may store instructions to cause the one or more processors to implement part or all of the method described above. Additional, fewer, or alternative features described herein below may be included in some aspects.

### BRIEF DESCRIPTION OF DRAWINGS

Advantages will become more apparent to those skilled in the art from the following description of the preferred embodiments which have been shown and described by way of illustration. As will be realized, the present embodiments may be capable of other and different embodiments, and their details are capable of modification in various respects. Accordingly, the drawings and description are to be regarded as illustrative in nature and not as restrictive.

The Figures described below depict various aspects of the applications, methods, and systems disclosed herein. It should be understood that each Figure depicts an embodiment of a particular aspect of the disclosed applications, systems and methods, and that each of the Figures is intended to accord with one or more possible embodiments thereof. Furthermore, wherever possible, the following description refers to the reference numerals included in the following Figures, in which features depicted in multiple Figures are designated with consistent reference numerals.

FIG. 1 illustrates a block diagram of an exemplary virtual environment system on which the methods described herein may operate, in accordance with embodiments described herein;

FIG. 2 illustrates a block diagram of an exemplary virtual environment interface device via which a user may access a virtual environment, in accordance with embodiments described herein;

FIG. 3A illustrates a flow diagram of an exemplary computer-implemented method for automatically generating a synthetic representative.

FIG. 3B presents a table that provides an example of a synthetic representative profile and types of data and data structures that may be included in the synthetic representative profile.

FIG. 4A presents a first exemplary virtual environment having a first synthetic representatives as provided to a user of a VR device.

FIG. 4B presents a second exemplary virtual environment having a second synthetic representative as provided to a user of a VR device.

FIG. 5 illustrates a flow diagram an exemplary computer-implemented method for generating personalized virtual content for a user in a virtual environment.

FIG. 6 illustrates an exemplary virtual landscape that may be generated and provided to one or more users in a virtual environment via the techniques described herein.

The Figures depict preferred embodiments for purposes of illustration only. One skilled in the art will readily recognize from the following discussion that alternative embodiments of the systems and methods illustrated herein may be employed without departing from the principles of the invention described herein.

### DETAILED DESCRIPTION

The systems and methods herein may generally relate to, inter alia, improvements to virtual reality (VR) and augmented reality (AR) systems and to improvements in the use thereof. Particularly, the systems and methods herein may generate and provide a synthetic representative of a user of a VR system. A synthetic representative may generally include a virtual visual representative of an individual. The synthetic representative may include recorded audio or synthetic audio that emulates the voice, cadence, tone, accent, and any other audible characteristics of a person. These synthetic representatives may be representative of a customer, consumer of a product, insurance agent, representative of a company, or another person. Synthetic representatives may be generated from aggregated data and the generated synthetic representative may be representative of characteristics of groups or categories of people (e.g., based upon sex, gender, age, ethnicity, etc.). The synthetic representatives may be generated partially or entirely using artificial intelligence or other processing techniques.

The systems and methods herein additionally may relate to generating personalized content for a user in a VR environment. For example, the personalized content may include an insurance offer, information requested by the user, virtual objects (e.g., a house, chair, car, kiosk, etc.), virtual quizzes and tests, informational content (e.g., visual information, audio information, etc.) etc. The personalized content may be generated based upon a user, for example, the content may include an insurance quote that is visually provided to the user in the VR environment, or the personalized content may be an insured item that is to be inspected in the virtual environment by the user of a virtual headset.

The techniques described herein improve existing VR systems and applications by providing automated generation of representatives in a virtual environment, the representatives provided to a user without requiring manual design of the representatives. The various visual and auditory characteristics of the synthetic representatives must consider diverse and complex aspects of a procedurally generated representation of a person to correctly represent the individual in the virtual environment. Additionally, the personalized content may be generated automatically to remove the requirement for a user to update or reprogram a training module according to a specific user. The personalized content may also be generated in response to a user input such as a user answering a question, presenting an inquiry to an input of the headset, or interacting with an object in the virtual environment.

While described herein as pertaining to VR systems, present embodiments may include the use of extended reality (XR) systems, XR devices, XR methods, and XR environments for obtaining and handling estate data, mixed reality (MR) systems, and/or smart glasses or smart contacts.

### Overview of Terms

For the sake of clarity of this detailed description, definitions of some relevant terms should first be set forth.

“Real property,” “one or more properties,” and the like as described herein, refer to a unitary area of land that may be owned, rented, leased, or otherwise utilized by one or more persons, one or more commercial businesses, one or more non-profit organizations, and/or other entities. A real property may, for example, include a residential home, an apartment building, a commercial business, an office of a business or nonprofit organization, an area of farmland, and/or another type of property utilized for any commercial or noncommercial purposes. Unless otherwise clear from context, other references to “property” may include real or personal property. An “entity” or “entity associated with a real property,” as described herein, refers to one or more persons, businesses, non-profit organizations, municipal entities, etc., that may own, rent, lease, or otherwise claim authority upon the real property.

Accordingly, in the context of this detailed description, “a virtual property” refers to a virtual representation of a real property, and “virtual property” may refer to a virtual representation of real or personal property. In some embodiments, a virtual property may be procedurally generated via techniques described herein, and thus the virtual property may not correspond directly to an actual real property, but rather to a property that may theoretically be present in a landscape.

In some embodiments, though, virtual properties may additionally or alternatively include properties modeled to closely represent existing residential, commercial, and/or other properties. For example, a virtual property may include a particular type of construction (e.g., log, brick, or stone construction) in accordance with typical construction of a certain property and/or region that the virtual property is intended to broadly represent. Accordingly, it should be understood that, where an “entity associated with a virtual property” is described herein, the entity may not refer to an actual entity, but may rather refer to an abstract entity that would be associated with the virtual property.

A “virtual landscape,” as described herein, generally refers to a virtual representation of a theoretical geographical area such as a town, city block, shopping mall, strip mall, or area upon which properties may be present. The virtual landscape is made up of various “components.” Components of a virtual landscape may include (1) one or more virtual properties, including the individual parts thereof, (2) natural terrestrial or aquatic elements (e.g., hills, mountains, rocks, vegetation, rivers, streams, lakes, ponds, beaches, shorelines, etc.), (3) infrastructural components (e.g., roads, sidewalks, traffic lights, streetlights, street signs, utility pipes, radio antennas, public transportation vehicles or other vehicles, etc.), (4) other man-made structures or objects (e.g., statues, trash bins, etc.), (5) meteorological elements (e.g., clouds, rain, sun, snow, fog, and/or other elements pertaining to weather), and/or other elements including those described herein. Components of a virtual landscape may be considered modular, in that one component may be made upon of two or more “sub-components.” For example, a virtual property may be made up of various sub-components thereof such as windows, walls, roofs, foundations, utility lines, furniture, etc. Moreover, components of a virtual landscape may comprise modifiable characteristics such as shape, size, rotation, material composition, color, texture, other ornamental aspects, etc. Modularity and variance of characteristics of components of a virtual landscape may facilitate uniqueness of two or more instances of any one component (e.g., two or more unique buildings or two or more unique terrain patterns).

A “virtual experience” as used herein, generally refers to the various virtual visual and auditory stimuli provided to a user of a virtual experience device. For example, a virtual experience may include a two-dimensional or three-dimensional graphic, an animation, a video, or another type of visual representation. The virtual experience may provide virtual visual representations of environments, landscapes, homes, rooms, vehicles, buildings, avatars, people, animals, text, and objects that a user may simply observe, or possibly interact with. The virtual experience may include providing a user with recorded audio, computer generated audio, music, voices, or any other type of auditory stimuli. Additionally, the virtual experience may include recording or transmitting audio from a user of the virtual experience device through a microphone. The virtual experience may include a conversation with a virtual avatar, a lecture, a tour of a virtual environment, a training session administered in a virtual environment or by a virtual representation of a person, or another type of virtual experience.

An “aspect” of a virtual landscape may generally refer to various observable traits of the virtual landscape. An aspect of the virtual landscape may refer, for example, to (1) the presence or absence of a particular one or more components (or sub-components thereof), (2) a characteristic of a present component (e.g., construction material of a property), and/or (3) a location of a component relative to one or more other components (e.g., proximity of a property to a flood plain or to another commercial property). Aspects may affect insurability of a virtual property in that, for example, the aspect is associated with (1) increased or decreased risk to the property as a result of weather patterns or natural disasters, (2) increased or decreased risk as a result of human activity (e.g., from vehicle impact, from use/production of hazardous materials at another nearby property, and/or from utility related damage), (3) increased or decreased monetary value (e.g., due to property being situated upon or near valuable land), and/or (4) eligibility of the property to be insured under a particular category of insurance policy (e.g., homeowners insurance, renters insurance, commercial insurance, etc.). Just as an aspect of the virtual landscape may affect insurability of a property, the aspect may further affect insurability of an entity associated therewith. In an envisioned use case, an objective of a “trainee” user in the virtual environment includes correctly identifying one or more aspects of a virtual landscape that may affect insurability of a virtual property therein, and/or of an entity associated therewith.

In embodiments described herein, “procedural generation” refers to automatic generation of at least portions of a virtual landscape according to one or more computing algorithms and/or rule sets. One or more algorithms may, for example, be associated with one or more input parameters or a map seed (e.g., an initial text string or integer fed to a rule-based generator) to generate at least a portion of the components of the virtual landscape. Generating a component, as described herein, may include determining any appropriate sub-components or characteristics of that component as described above (e.g., to define size, placement, and relative arrangement of components). Procedural generation techniques may operate within confines of one or more predefined rules which may, for example, define conditions upon which certain components of the virtual landscape may appear, or define a manner in which components can or cannot be relatively arranged. In some embodiments, procedural generation techniques may include use of components and/or rules from a preexisting library of components and/or rules stored at one or more computing devices.

Use of procedural generation techniques thus stands in contrast to conventional techniques typically used in virtual environment generation for training. According to such techniques, each and every component of the virtual environment may need to be manually selected and placed by a human programmer or designer, without potential for variability across two or more virtual environments except through manual configuration of those two or more environments by the human.

The virtual environment may implement various “virtual tools” via which a user may interact with the virtual environment, and via which one or more computing devices implementing the virtual environment may obtain “user interaction data” in accordance with the user's interaction with the environment. Without limitation, implemented virtual tools may include (1) “user tools” actively engaged by the users to move about the virtual environment and/or manipulate the environment (to grab, collect, move, or annotate potentially significant components) and/or (2) “tracking tools” employed by the one or more computing devices implementing the virtual environment to detect user interaction independently of active input by the user (e.g., an eye tracking tool, a field of vision tracking tool, a visual focus tracking tool, etc.). One or more computing devices may determine, based upon received user interaction data, whether the user has correctly identified one or more aspects affecting insurability of a virtual property and/or entity associated therewith.

### Exemplary Computing Environment

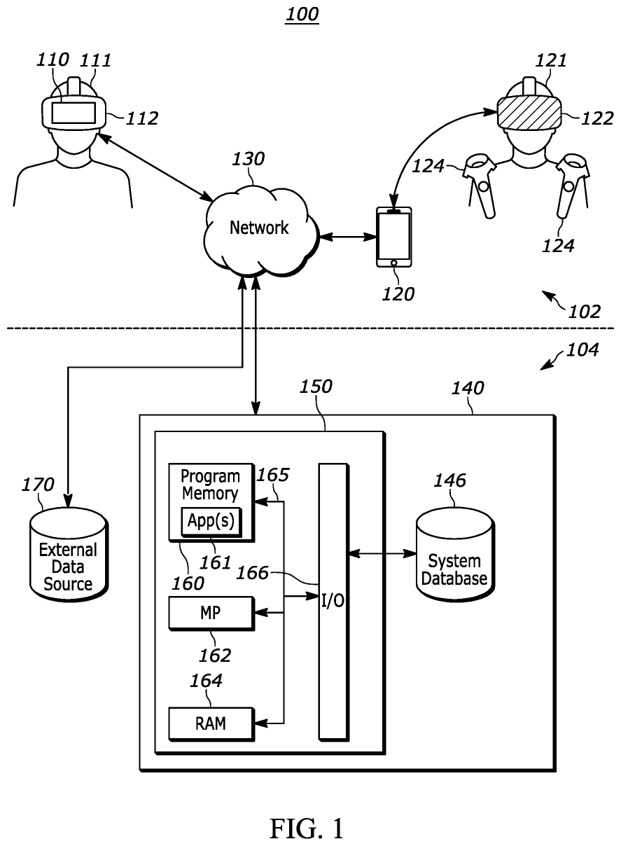

FIG. 1 illustrates a block diagram of an exemplary virtual experience system 100 that may operate to implement (e.g., generate and provide to one or more users) a synthetic representative including a computer-executed method for automatically generating a virtual synthetic representative of a person. As described herein, synthetic representative may also be considered a virtual person, avatar, digital representative, or digital person. The high-level architecture includes both hardware and software applications, as well as various data communications channels for communicating data between the various hardware and software components. The virtual experience system 100 may include additional, fewer, and/or alternate computing components, including those described herein. The virtual experience system 100 may be roughly divided into front-end components 102 and back-end components 104.

The front-end components 102 generally may allow one or more users to interact with a virtual environment and/or synthetic representative via one or more virtual experience interface devices that may be physically accessible to the one or more users. Generally, such one or more virtual experience interface devices may include (1) one or more computing devices suitable for performing local processing, transmitting data over one or more networks, processing user input, and/or other computing actions described herein, and (2) one or more display/input devices suitable for visually and/or otherwise presenting a virtual environment, presenting objects and avatars in the virtual environment, receiving user input, etc. Accordingly, as depicted by FIG. 1 and described herein, one or more virtual experience interfaces may include, for example, a mobile computing device 110 (e.g., a smartphone) and/or a dedicated VR system 120. It should be appreciated, though, that other types and combinations of virtual experience interface devices may be used (e.g., various mobile or stationary computing devices, wearable computing devices, and/or other devices described herein).

In any case, the front-end components 102 may communicate with the back-end components 104 via a network 130 (i.e., one or more networks). Generally, the back-end components 104 may include one or more servers 140 that may communicate with the front-end components 102 and/or one or more external data sources 170. In some embodiments, as will be described in subsequent sections of this detailed description, the one or more servers 140 may be configured to provide a virtual experience simultaneously to two or more users via communications over the network 130. The network 130 may include a proprietary network, a secure public internet, a virtual private network or some other type of network, such as dedicated access lines, plain ordinary telephone lines, satellite links, cellular data networks, combinations of these, and/or other network(s). Where the network 130 comprises the Internet, data communications may take place over the network 130 via an Internet communication protocol.

Returning to the discussion of the front-end components 102, an example mobile computing device 110 may be associated with a mobile device user 111. The mobile computing device 110 may include a tablet computer, smartphone, wearable computer device (e.g., backpack, headset, smart watch, smart glasses, augmented reality glasses, virtual reality headset, or smart watch), and/or similar devices. The mobile computing device 110 may include one or more position sensors (e.g., accelerometers, gyroscopes, or inertial measurement units) and a display screen. The positions sensors may provide data regarding position and movement of the mobile computing device 110 to facilitate determination of position or viewing perspective within the virtual environment. The display screen may be used to present a visual representation of a view of a virtual environment and/or one or more synthetic representatives.

The mobile device user 111 may thereby interact with the mobile computing device 110 to access and navigate a virtual environment and interact with the virtual environment or synthetic representatives, in accordance with embodiments described herein. Use of the mobile computing device 110 by the mobile device user 111 may include mounting the mobile computing device 110 within a head mount 112 (and/or another equivalent mounting apparatus) for hands-free use and a more immersive user experience, in some embodiments.

An exemplary virtual reality system 120 may include a general-purpose computer and/or a special-purpose computer specifically designed for virtual reality applications. Accordingly, the virtual reality system 120 may include, for example, a stationary computer (e.g., desktop PC), mobile computing device, wearable device (e.g., backpack-mounted computer), and/or any suitable combinations thereof. The virtual reality system 120 may include or interface with one or more displays 122 to present a visual representation of a view of a virtual environment and/or synthetic representative to the VR system user 121. Furthermore, the virtual reality system 120 may include or interface with one or more input devices 124 (e.g., wired/wireless handheld input devices) to receive user input (i.e., user interaction) from the VR system user 121. In some embodiments, a display 122 and input devices 124 may be connected to the virtual reality system 120 as peripheral components. Moreover, in some embodiments, the display 122 and/or the one or more input devices 124 may similarly interface with the example mobile computing device 110 and/or other virtual experience interface devices described herein.

Although only one mobile computing device 110 of one mobile device user 111 and one virtual reality system 120 of one VR system user 121 are illustrated, it will be understood that, in some embodiments, various combinations of virtual experience interface devices and users thereof are envisioned. For example, the front-end components 102 may include any suitable number of virtual experience interface devices, including any devices or combinations of devices described herein. Moreover, in some embodiments, a single virtual experience interface device may provide a virtual environment and/or synthetic representative(s) to two or more users.

Naturally, computing capabilities may significantly differ among various virtual experience interface devices utilized to access a virtual environment or interact with a synthetic representative. For example, a special-purpose, dedicated virtual reality device may, in some circumstances, have superior processing and/or display capabilities when compared to some general-purpose laptop computers, desktop computers, and smartphones. Accordingly, in some embodiments, the server 140 may adaptively implement a virtual experience that provides a virtual environment and/or generates and provides one or more synthetic representatives according to the computing capabilities of one or more front-end components to be used to access the virtual experience, in some embodiments. In some embodiments, for example, one or more virtual experience interface devices among the front-end components 102 may include a “thin-client” device, wherein computing actions by the thin-client device may be limited, for example, to just those necessary computing actions to visually display a virtual environment and/or receive user input, while back-end components 104 perform most or all remaining computing actions to generate a virtual environment, generate a synthetic representative, analyze user input, etc. Such techniques may be particularly effective, for example, in emerging 5G computing networks and other networks characterized by high data transmission rates.

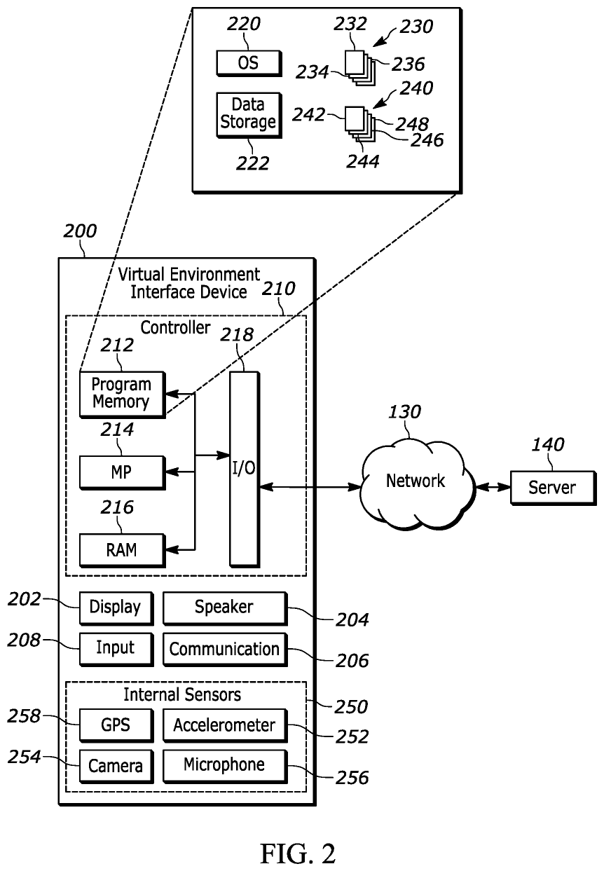

Each virtual experience interface device may include any number of internal sensors and may be further communicatively connected to one or more external sensors by any known wired or wireless means (e.g., USB cables, Bluetooth communication, etc.). The mobile computing device 110 and virtual reality system 120 are further discussed below with respect to FIG. 2.

It should be noted that, in this detailed description, “user” or similar terms may be used as shorthand to refer to a front-end component 102 performing actions and/or accessing data in association with a human user. Thus, as an example, “providing a synthetic representative to a user” may comprise providing a synthetic representative to one or more front-end components 102 for use by a user. Similarly, “receiving data from a user,” or similar terms, may refer to receiving data transmitted via one or more front-end components automatically or in response to input by a user at the one or more front-end components 102. The back-end components 104 may include one or more servers 140 communicatively connected to the network 130.

Each server 140 may include one or more processors 162 adapted and configured to execute various software applications and components of the virtual experience system 100, in addition to other software applications. The server 140 may further include a database 146, which may be adapted to store data related to the system 100, such as virtual environments, virtual landscapes, graphical assets used to generate virtual landscapes, rules used to generate virtual landscapes, synthetic representatives, graphical assets to generate synthetic representatives, audio data for generating synthetic representatives, user interaction data, image/video captures from virtual environments, data pertaining to a user, and/or similar data, which the server 140 may access to perform actions described herein. The server 140 may include a controller 150 that is operatively connected to the database 146.

It should be noted that, while not shown, additional databases may be linked to the controller 150 in a known manner. The controller 150 may include a program memory 160, a processor 162, a RAM 164, and an I/O circuit 166, all of which may be interconnected via an address/data bus 165. It should be appreciated that although only one microprocessor 162 is shown, the controller 150 may include multiple microprocessors 162. Similarly, the memory of the controller 150 may include multiple RAMs 164 and multiple program memories 160. Although the I/O circuit 166 is shown as a single block, it should be appreciated that the I/O circuit 166 may include a number of different types of I/O circuits, which may process user input (e.g., via keyboard, mouse, voice, etc.) and/or provide user output (e.g., via a visual display, audio output device, etc.). The RAM 164 and program memories 160 may be implemented as semiconductor memories, magnetically readable memories, or optically readable memories, for example.

The server 140 may further include a number of software applications or routines 161 (“App(s)”) stored in the program memory 160. In some embodiments, these applications or routines 161 may form modules when implemented by the processor 162, which modules may implement part or all of the methods described below to implement virtual environments and/or synthetic representatives among one or more users, record sessions within virtual environments or with synthetic representatives, present recordings of virtual environment sessions or synthetic representative sessions, and/or process user interaction in virtual environments and with synthetic representatives.

In some embodiments, such modules may include one or more of a virtual landscape generation module, synthetic representative generation module, a communication channel module, a collaborative session management module, a virtual environment presentation module, synthetic representative presentation module, a data recordation module, and/or a review module. Additionally or alternatively, the modules may include one or more modules that enable a user to define, via one or more interactive graphical user interfaces, graphical assets to be used as components within virtual landscape or synthetic representatives, and/or rule sets to be used in generation of components of virtual landscapes or features of synthetic representatives. User-defined graphical assets and/or rules may be stored via the system database 146, in some embodiments.

The back-end components 104 may further include one or more external data sources 170, communicatively connected to the network 130. The one or more external data sources 170 may, for example, include public or proprietary databases storing information that may be associated with physical real properties such as ownership records, zoning data, tax assessments, environmental reports, business listings, or insurance policies. The data sources 170 may further store information pertaining to a user or user account information, for example, an identification as a customer, an identification as an insurance agent, an age, ethnicity, sex, gender, a physical features (e.g., hair color, hair style, eye color, face shape, eye shape, eyewear, facial hair, hair style, etc.), voice recordings, etc.

In some embodiments, such information retrieved via the one or more external data sources may be used to generate rule sets for use in generating virtual landscapes or a set of rules in generating a synthetic representative, so as to generate virtual landscapes that realistically resemble hypothetical physical environments and to generate synthetic virtual representatives that realistically resemble individual people. Additionally or alternatively, in some embodiments, the one or more external data sources 170 may include graphical assets and/or rules that may be used to generate components of virtual landscapes or physical and audible features of synthetic representatives.

### Exemplary Virtual Experience Interface Device

FIG. 2 illustrates a block diagram of an exemplary virtual experience interface device 200 that may provide access to virtual environments and synthetic representatives. The virtual experience interface device 200 may include any suitable device or combination of devices described herein (e.g., the example mobile computing device 110, the example virtual reality system 120, etc.).

The virtual experience interface device 200 includes one or more internal sensors 250 which may provide sensor data regarding a local physical environment in which the virtual experience interface device 200 is operating. In some embodiments, one or more of such internal sensors 250 may be integrated into an inertial measurement unit (IMU)). Sensor data provided via the one or more sensors 250 data may include, for example, accelerometer data, rotational data, and/or other data used to position the virtual experience interface device 200 within its local physical environment. Position of the virtual experience interface device 200 may, in turn, be used to position and navigate (e.g., move, rotate, etc.) the user within the virtual environment. In some embodiments, any of the sensors discussed herein may be peripheral to the virtual experience interface device 200. In any case, the sensor data may be processed by the controller 210 to facilitate user interaction with the virtual environment and/or with a synthetic representative, as discussed elsewhere herein. Additionally, or alternatively, the sensor data may be transmitted to one or more processors 162 of the server 140 through the network 130 for processing.

The virtual experience interface device 200 includes a display 202, which may be used to present a visual representation of a virtual environment and/or synthetic representative to the user. The visual representation of the virtual environment includes a plurality of views at positions within the virtual environment, which are presented to the user as the user navigates around the virtual environment. Additionally, the visual representation of the synthetic representative includes a plurality of views at different angles of the synthetic representative as a user may move around the synthetic representative, or as the synthetic representative may move in the virtual environment. The virtual experience interface device 200 also includes a speaker 204, which may be used to present sounds associated with the virtual environment, audio from the synthetic representative, or communications from other users during a virtual environment session. The virtual experience interface device 200 likewise includes an input 208 to receive user input from the user, which may include various user interactions with the virtual environment or with a synthetic representative, in some embodiments. Each of the display 202, speaker 204, or input 208 may be integrated into the virtual experience interface device 200 or may be communicatively connected thereto.

The display 202 may include any known or hereafter developed visual or tactile display technology, including LCD, OLED, AMOLED, projection displays, refreshable braille displays, haptic displays, or other types of displays. The one or more speakers 204 may similarly include any controllable audible output device or component. In some embodiments, communicatively connected speakers 204 may be used (e.g., headphones, Bluetooth headsets, docking stations with additional speakers, etc.). Such input 208 may include a physical or virtual keyboard, a microphone, virtual or physical buttons or dials, or other means of receiving information. In some embodiments, the display 202 may include a touch screen or otherwise be configured to receive input from a user, in which case the display 202 and the input 208 may be combined.

The internal sensors 250 may include any devices or components mentioned herein, along with other extant devices suitable for capturing data regarding a physical environment of a virtual experience interface device 200 or presenting communication data or data regarding a virtual environment (e.g., representations of components of virtual landscapes or representations of user annotations within the virtual landscape) or of a synthetic representative (e.g., representative name or title, text communication from the representative, a selectable choice presented by the representative, etc.). In some embodiments, the sensors 250 may further include additional sensors configured or intended for other uses, such as geolocation, photography, or spatial orientation (e.g., position and/or rotation) of the device.

Although discussion of all possible sensors of the mobile computing device 110 would be impractical, if not impossible, several particular sensors warrant particular discussion. Disposed within the virtual experience interface device 200, the internal sensors 250 may include an accelerometer 252, a camera 254, a microphone 256, and/or a GPS unit 258. Any or all of these may be used to generate sensor data used in generating or interacting with virtual environments representing theoretical geographical areas, or with synthetic representatives that represent individual people, or representative of data aggregated from a demographic of a type of people. Additionally, other types of currently available or later-developed sensors (e.g., a gyroscope and/or magnetometer) may be included in some embodiments. In some embodiments, the one or more internal sensors 250 may include one or more external sensors communicatively connected to the mobile computing devices. Such sensors may, for example, be disposed within one or more input devices 124, or may be standalone sensors communicatively connected to other computing elements described herein.

The accelerometer 252 may include one or more accelerometers positioned to determine the force and direction of movements of the virtual environment interface device 200. In some embodiments, the accelerometer 252 may include a separate X-axis accelerometer, Y-axis accelerometer, and Z-axis accelerometer to measure the force and direction of movement in each dimension, respectively. It will be appreciated by those of ordinary skill in the art that a three-dimensional vector describing a movement of the virtual experience interface device 200 through three-dimensional space can be established by combining the outputs of the X-axis, Y-axis, and Z-axis accelerometers using known methods.

Similarly, other components may provide additional positioning or movement sensor data. In some embodiments, a gyroscope may be used in addition to, or instead of, the accelerometer 252 to determine movement of the virtual experience interface device 200. For example, a MEMS gyroscope may be included within the virtual experience interface device 200 to detect movement of the virtual experience interface device 200 in three-dimensional physical space. Of course, it should be understood that other types of gyroscopes or other types of movement-detecting sensors (e.g., a magnetometer) may be used in various embodiments. Such sensor data may be used to determine a relative position of the virtual experience interface device 200 within its local physical environment. In some instances, such relative position information may be used to navigate an existing virtual environment by movements of the virtual experience interface device 200 within the local physical environment.

The camera 254 (i.e., one or more camera devices) may be used, for example, to monitor and provide tracking data for a VR headset and/or another virtual experience interface device 200. Additionally or alternatively, the camera 254 may provide hand or finger tracking of the user in the local physical environment. Still additionally or alternatively, the camera 254 may capture the local physical environment to provide a “pass-through” view of the local physical environment, such that a user whose local environment may be obscured by a VR headset may obtain at least a partial view of people and/or objects in the local physical environment, while simultaneously interacting with the virtual environment or synthetic representative. One or more cameras 254 disposed within the virtual experience interface device 200 may include an optical camera, an infrared camera, and/or other types of cameras.

The microphone 256 may be used to detect sounds within the local physical environment, such as spoken notes or comments by the user of the virtual experience interface device 200, which spoken notes or comments may be used to detect a user's identification of aspects of a virtual landscape that may affect insurability, and/or to add annotations within a virtual landscape. The microphone 256 may capture speech from a user to ask a synthetic representative a question, or to confirm or provide an answer to a synthetic representative. In some embodiments, microphone 256 may likewise be used to capture spoken messages for communication between two or more users during a virtual session. One or more microphones 256 may be disposed within the virtual experience interface device 200 or may be communicatively connected thereto. For example, wired or wireless microphones 256 may be communicatively connected to the virtual experience interface device 200, such as wireless speaker/microphone combination devices communicatively paired with the virtual experience interface device 200.

The GPS unit 258 may provide information regarding the location or movement of the virtual experience interface device 200. The GPS unit 258 may use “Assisted GPS” (A-GPS), satellite GPS, or any other suitable global positioning protocol (e.g., the GLONASS system operated by the Russian government) or system that locates the position of the virtual experience interface device 200. For example, A-GPS utilizes terrestrial cell phone towers or Wi-Fi hotspots (e.g., wireless router points) to more accurately and more quickly determine location of the virtual experience interface device 200, while satellite GPS generally is more useful in more remote regions that lack cell towers or Wi-Fi hotspots.

The virtual experience interface device 200 may also communicate with the server 140, the one or more external data sources 170, and/or other components via the network 130. For example, the virtual experience interface device 200 may communicate with another virtual experience interface device 200 (e.g., another front-end component 102 depicted in FIG. 1) during a virtual session by communication through the server 140 via the network 130. Such communication may involve the communication unit 206, which may manage communication between the controller 210 and external devices (e.g., network components of the network 130, etc.).

The communication unit 206 may further transmit and receive wired or wireless communications with external devices, using any suitable wireless communication protocol network, such as a wireless telephony network (e.g., GSM, CDMA, LTE, etc.), a Wi-Fi network (802.11 standards), a WiMAX network, a Bluetooth network, etc. Additionally, or alternatively, the communication unit 206 may also be capable of communicating using a near field communication standard (e.g., ISO/IEC 18092, standards provided by the NFC Forum, etc.). Furthermore, the communication unit 206 may provide input signals to the controller 210 via the I/O circuit 218. The communication unit 206 may also transmit sensor data, device status information, control signals, and/or other output from the controller 210 to the server 140 or other devices via the network 130.

The virtual experience interface device 200 further includes a controller 210 that may receive, process, produce, transmit, and/or store data. The controller 210 may include a program memory 212, one or more microcontrollers or microprocessors (MP) 214, a random access memory (RAM) 216, and/or an I/O circuit 218. The components of the controller 210 may be interconnected via an address/data bus or via other means. It should be appreciated that although FIG. 2 depicts only one microprocessor 214, the controller 210 may include multiple microprocessors 214, in some embodiments. Similarly, the memory of the controller 210 may include multiple RAMs 216 and multiple program memories 212. Although FIG. 2 depicts the I/O circuit 218 as a single block, the I/O circuit 218 may include a number of different I/O circuits, which may be configured for specific I/O operations. The microprocessor 214 may include one or more processors of any known or hereafter developed type, including general-purpose processors or special-purpose processors. Similarly, the controller 210 may implement the RAM 216 and program memory 212 as semiconductor memories, magnetically readable memories, optically readable memories, or any other type of memory.

The program memory 212 may include an operating system 220, a data storage 222, a plurality of software applications 230, and a plurality of software routines 240. The operating system 220, for example, may include one of a plurality of mobile platforms such as the iOS®, Android™, Palm® webOS, Windows® Mobile/Phone, BlackBerry® OS, or Symbian® OS mobile technology platforms, developed by Apple Inc., Google Inc., Palm Inc. (now Hewlett-Packard Company), Microsoft Corporation, Research in Motion (RIM), and Nokia, respectively. The data storage 222 may include data such as user profiles and preferences, application data for the plurality of applications 230, routine data for the plurality of routines 240, and other data necessary to interact with the server 140 through the digital network 130. In some embodiments, the controller 210 may also include, or otherwise be communicatively connected to, other data storage mechanisms (e.g., one or more hard disk drives, optical storage drives, solid state storage devices, etc.) that reside within the virtual environment interface device 200. Moreover, in some embodiments, such as thin-client implementations, additional processing and data storage may be provided by the server 140 via the network 130.

The software applications 230 and routines 240 may include computer-readable instructions that cause the processor 214 to implement various functions of virtual experience sessions, as described herein. Thus, the software applications 230 may include a virtual reality application 232 to present a virtual environment or a synthetic representative to a user, a communication application 234 to send and receive real-time communication with one or more other users via a communication channel, and a network communication application 236 to receive and transmit data via the network 130. The software routines 240 may support the software applications 230 and may include routines such as a relative position tracking routine 242 to process sensor data to maintain a relative position of the virtual experience interface device 200 within a physical environment, a virtual position tracking routine 244 for determining a corresponding virtual position within the virtual environment, a user annotation routine 246 to generate user annotations within the virtual environment based upon user input, generate a personalized virtual environment, provide a training session to a user, provide personalized virtual content to a user, provide a synthetic representative to a user, and/or a virtual object measurement routine 248 to determine physical dimensions or measurements based upon virtual measurements within the virtual environment. It should be understood that additional or alternative applications 230 or routines 240 may be included in the program memory 212, including web browsers or other applications.

In some embodiments, the virtual experience interface device 200 may include a wearable computing device or may be communicatively connected to a wearable computing device. In such embodiments, part or all of the functions and capabilities of the virtual experience interface device 200 may be performed by or disposed within the wearable computing device. Additionally, or alternatively, the wearable computing device may supplement or complement the virtual experience interface device 200. For example, the virtual experience interface device 200 may be communicatively connected to a smart watch or head-mounted display. Additionally or alternatively, in some embodiments, the virtual experience interface device 200 may be communicatively connected to further auxiliary devices mounted on feet, hips, hands, etc. of the user. Such further tracking devices may provide auxiliary tracking capabilities to better monitor the user's interaction with the virtual environment, and/or may provide feedback (e.g., haptic feedback) to enhance a user's experience in the virtual environment or with a synthetic representative.

Various embodiments of the virtual experience system 100 described above and illustrated in FIGS. 1 and 2 may be utilized to perform the methods discussed further below.

### Shared Virtual Environments

In some embodiments, the server 140 may implement a shared virtual experience that enables two or more users to simultaneously navigate a virtual environment including a virtual landscape. For example, a shared virtual environment may be used in interactions between a customer, and an insurance agent, or to allow both an instructor and a trainee to both share a virtual environment for training purposes. To implement a shared virtual environment among two or more users, the server 140 may send data to and/or receive data from two or more virtual experience interface devices 200 via the network 130. While a two-user virtual environment is described herein, it should be understood that via these techniques, any suitable number of users may share a virtual environment simultaneously.

In some embodiments, where two or more virtual environment interface devices 200 have differing computing capabilities (e.g., a comparatively high-capability special-purpose VR system and a comparatively low-capability, general-purpose smartphone), the server 140 may establish and maintain the shared virtual environment session by providing different data to the two or more different virtual experience interface devices 200 in accordance with their computing capabilities. For example, the server 140 may provide, to a first high-capability virtual experience interface device, a high-fidelity virtual environment, and further provide, to a second low-capability virtual experience interface device, a comparatively low-fidelity virtual environment that corresponds to the high-fidelity virtual environment, but comprises less data than the high-fidelity virtual environment. The low-fidelity virtual environment may, for example, include a lower graphical resolution, display fewer components, and/or be provided at a lower frames-per-second count in order to reduce data transmission and computing demand at the low-capability device.

In any case, to implement a shared virtual experience, the server 140 may establish one or more communication channels for substantially real-time bidirectional communication between two users. The one or more communication channels may include a text communication channel, a voice communication channel (e.g., voice-over-Internet-protocol (VOIP) channel), and/or another one or more suitable communication channels. The establishment of the one or more communication channels may enable two users to view synthetic representations of one another in the virtual environment based upon transmitted tracking data. Moreover, in some embodiments, the establishment of the one or more communication channels may enable two users to guide one another's movement and/or focus in the shared virtual experience.

In one example implementation of a shared virtual experience, the server 140 may generate a virtual landscape and provide the generated virtual landscape to a first “expert trainer” user and a second “trainee” user (e.g., via respective second virtual experience interface devices 200). Through the establishment of the shared virtual experience between the trainer and trainee users, the trainer user may observe the trainee user's navigation throughout the virtual landscape to identify aspects of the virtual landscape affecting insurability of one or more virtual properties and/or entities. In some embodiments, either or both users may be represented in the virtual environment via respective virtual avatars whose movement about the virtual environment may be controlled via input from the respective user.

In some embodiments, further virtual tools may be implemented in the shared virtual experience, via use of which the expert trainer user may improve the training experience of the trainee user. Such expert trainer tools may include, for example, a view control tool that enables the expert trainer user to control the movement and/or visual focus of the trainee user within the virtual environment. Furthermore, in a shared virtual experience, any use of suitable virtual tools by either user may be made visible to the other user in the shared environment. For example, if the expert trainer user uses an annotation tool to mark a particular component of the virtual landscape, the marking via the annotation tool may be viewable by the trainee user in a substantially real-time manner in the shared virtual experience. Thus, via use of communication channels and/or virtual tools in the shared virtual experience, two or more users may collaborate to direct each other's attention to particular components of a virtual landscape to successfully identify aspects affecting insurability of virtual properties and/or entities.

In another example of a shared virtual experience, the server 140 may generate a virtual environment such as an insurance office or room and provide the generated virtual environment to a first “customer” user and a second “insurance agent” user (e.g., via first and second virtual experience interface devices 200). The customer and insurance agent may have respective synthetic virtual representatives in the virtual environment. Through the synthetic virtual representatives, the customer may use input devices to type questions or answers, select options, fill out forms, speak to, ask a question, provide a verbal answer, or otherwise communicate with the insurance agent.

Similarly, the insurance agent may communicate with the customer via inputs to ask questions, provide answers, collect information, or provide information to the customer. The insurance agent may provide videos to the customer in the virtual environment to provide the customer with graphical information or commercials. As such, the shared virtual experience may facilitate interactions between multiple users via synthetic representatives in a virtual environment.

### Exemplary Method of Generating a Synthetic Representative

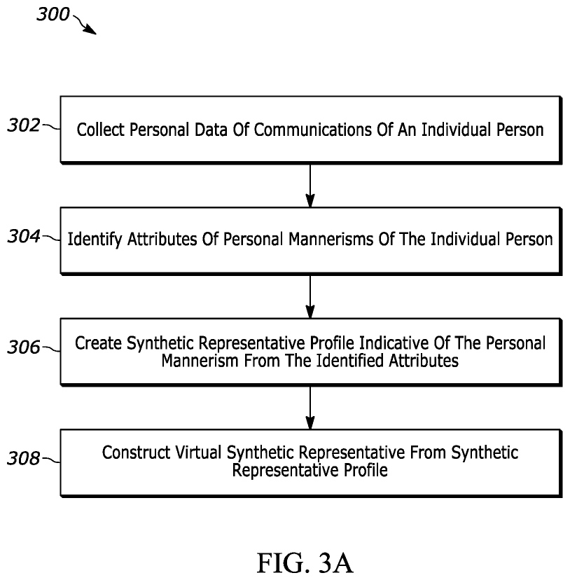

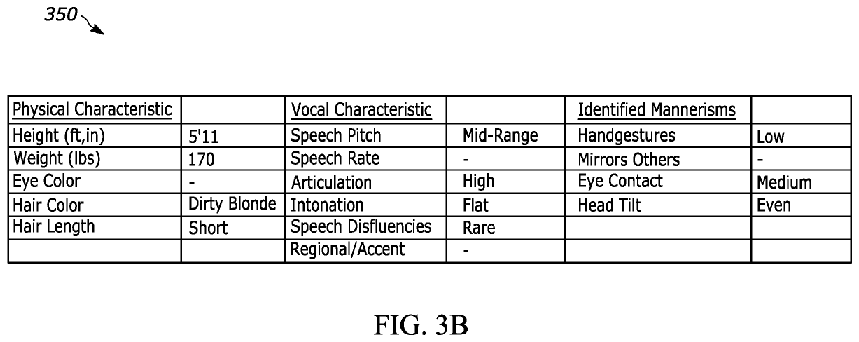

FIG. 3A illustrates a flow diagram of an exemplary computer-implemented method 300 for automatically generating a synthetic representative. The method may be implemented, for example, via computing elements of the virtual experience system 100 depicted in FIGS. 1 and 2 (e.g., via one or more processors executing non-transitory computer-executable instructions stored via one or more non-transitory computer-readable media or memories). In some embodiments, one or more computer-readable media may store non-transitory computer-executable instructions that, when executed via one or more processors, cause one or more computing devices to perform actions of the method 300. The method 300 may include additional, fewer, and/or alternate actions to those described herein, in some embodiments.

The method 300 may include, collecting, via one or more processors, and/or associated transceivers personal data regarding past communications of an individual person (302). The personal data may include any of one or more of voice recordings, photographs, images, videos, biometric data, etc. The personal data may be data from a social media account or other online data source.

To collect the personal data, the system 100 may scrape social media accounts to compile the data of the user. For example, the system 100 may access a social media account of a user and use images, voice recordings, or videos from the social media account as the personal data. In some embodiments, the personal data may include videos containing the individual person, such as those posted on video sharing platforms.

The personal data may be indicative or represents one or more observable characteristics of the individual the data is associated with. For example, the personal data may be indicative of a hair color, eye color, race, skin tone, race, height, body shape, hair style, facial hair, eyewear, etc. of the individual person. In addition to visual characteristics, the collected data may be indicative of other observable characteristics may include a vocal tone, inflection, speech pattern, language accent, or other audibly observable characteristics. In some embodiments, phone recordings or podcast recordings may be obtained as indicative of speech patterns of the individual person. The personal data may further include data indicative of expertise, associations, interests, or other facets of the individual person. For example, image or text from social media posts may indicate various hobbies (e.g., cycling, performing music, weight lifting, hiking, or sculpture) or events (e.g., concerts, sporting events, rallies, theatrical performances or festivals).

The method 300 next may include, via one or more processors, identifying one or more attributes indicative of personal mannerisms of the individual (304). For example, the one or more attributes may include one or more of a race, ethnicity, sex, gender, age, age range, lexicon, speech pattern, vocal intonation, physical feature, fashion style, personal interest, hobby, etc. To identify the one or more attributes indicative of personal mannerisms of the individual, the system 100 may process multiple images, videos, or audio recordings to determine the personal mannerisms. In some examples, the system 100 may train a machine learning algorithm using the collected personal data to determine and identify the one or more attributes indicative of the personal mannerisms of the person. Additionally, the system 100 may employ a machine learning algorithm or artificial intelligence (AI) algorithm to determine the attributes from the personal data.

In certain examples, the system 100 may analyze one or more videos of a person as the personal data. The system may perform image processing and machine vision processes to identify a face, features of the face (e.g., eyes, nose, lips, ears, eyewear, facial hair, etc.), arms, legs, shoulders, hair, etc. of a person in the video. The machine learning algorithm may then determine, based upon the one or more videos and identified features of the person, that the person uses a high amount of hand gestures. Therefore, the system 100 then identifies an attribute of the person that the person uses a lot of hang gestures. Additionally, the system 100 may analyze audio associated with the video, and may determine that the person speaks generally within a certain tonal range. Using the trained machine learning algorithm, the system 100 then identifies the attribute of having a specific vocal tone range as a mannerism. The system 100 may identify physical features and mannerisms using the machine learning technique, image analysis, audio analysis, and machine vision techniques.

The method 300 further may include, via one or more processors, creating a synthetic representative profile indicative of the personal mannerisms of the person from the one or more attributes (306). Creating the synthetic representative profile may include generating a list of one or more physical features or mannerisms of the individual person.

FIG. 3B presents a table 350 that provides an example of a type of data and data structures that may be included in the synthetic representative profile. For example, the system 100 may identify or estimate, from the personal data, a person's height, weight, eye color, hair color, hair length, hair style, clothing type, the presence or absence of earrings, hats, watches or other items, or other visual features or characteristics of the person.

Additionally or alternatively, the system 100 may identify, from the personal data, a speech pitch, speech rate or speed, an amount of articulation, a degree of intonation variation, any vocal disfluencies (e.g., pauses, miss-speaks, repeat words or sentences, etc.), an accent, or another vocal or speech based characteristic, mannerism, or feature of the person.

Further, the identified personal mannerisms may include hand gestures commonly performed by the person, an amount of hand gesturing, if the person typically mirrors others, a degree of eye contact, a physical positioning of the body (e.g., head tilt, leaning in a direction, leg stance, arm positioning, etc.), laughter frequency, smile frequency, smile degree, etc. In certain examples, the system 100 may not have enough personal data to identify a mannerism or observable (e.g., visual or audible) characteristic of a person and may leave that entry blank or remove the entry from the synthetic represented profile.

The method 300 may include, via one or more processors, virtually constructing a synthetic representative from the synthetic representative profile, the synthetic representative including a visual representation in a virtual environment (308). To construct the synthetic representative, the system 100 may train a machine learning algorithm using the collected personal data and/or synthetic representative profile, to generate virtual representations that mimic the personal mannerisms. For example, the system 100 may train the machine learning algorithm to generate visual representations of a man, woman, physical expression (e.g., facial expression, arm position or expression, stance, etc.), height, weight, body shape, color or shade of hair, color of eyes, etc. In some embodiments, constructing the synthetic representative may further comprise determining a plurality of automated scripts for the synthetic representative to use for autonomous interaction with other users within the virtual environment, such as automated responses to questions or requests from customers. Such automated scripts may be manually imported from script files defined by a user or may be automatically generated by machine learning algorithms based upon collected user data, such as that described above. The automated scripts may be used to provide personalized virtual content to customers or other users, as discussed further herein.

To train the machine learning algorithm, the system 100 may employ supervised learning (e.g., nearest neighbor, naïve Bayes, decision tree, linear regression, support vector machines, neural networks, etc.), unsupervised learning (e.g., clustering, association rules, dimensionality reduction, etc.), semi-supervised learning, or reinforcement learning (e.g., Q-learning, temporal difference, deep adversarial networks, etc.).

In one example, the system 100 may be provided with sets of personal data that are pre-assigned with associated attributes indicative of personal mannerisms of a person. The system 100 may be trained to identify the attributes based upon the provided data set, and then the machine learning algorithm may be provided with other sets of personal data to identify the attributes and personal mannerisms from the additional sets of personal data.

In an unsupervised example, the system may be provided with personal data and may identify patterns across sets of data without being provided with any knowledge of attributes of personal mannerisms. The system may then associate the identified patterns attributes of personal mannerisms via phot/video analysis, audio analysis, etc. and the model may then determine attributes of mannerisms based off of its own initial analysis of personal data and unsupervised training.

To generate the visual representation of the synthetic representative, the system 100 may, via one or more processors, further render the visual graphics to be presented in the virtual environment. In examples, the system 100 may apply one or more of shading, texture-mapping, bump-mapping, fogging/participation medium, shadows, reflections, transparencies, refractions, diffractions, illuminations, caustics, depths of field, blurs, non-photorealistic renderings, etc. to render the visual representation. Features of the synthetic representative, a virtual environment, virtual object, or any other visual presentation in the virtual experience may be rendered in a two-dimensional rendering or three-dimensional visual rendering. The system 100 may render the visual representation via scanline rendering, rasterization, ray casting, ray tracing, neural rendering, projections, or another rending algorithm or technique.

Additionally, to render the visual representations the system may further include performing radiosity, sampling and filtering, one or more optimizations, a physical simulation or emulation, etc. In some examples, the rendering may include processing two-dimensional images personal data, such as images and videos from a social media account, and rendering three-dimensional virtual objects from the two-dimensional personal data images (i.e., visual representations of synthetic representatives, virtual objects, virtual environments, etc.).

### Exemplary Virtual Environments

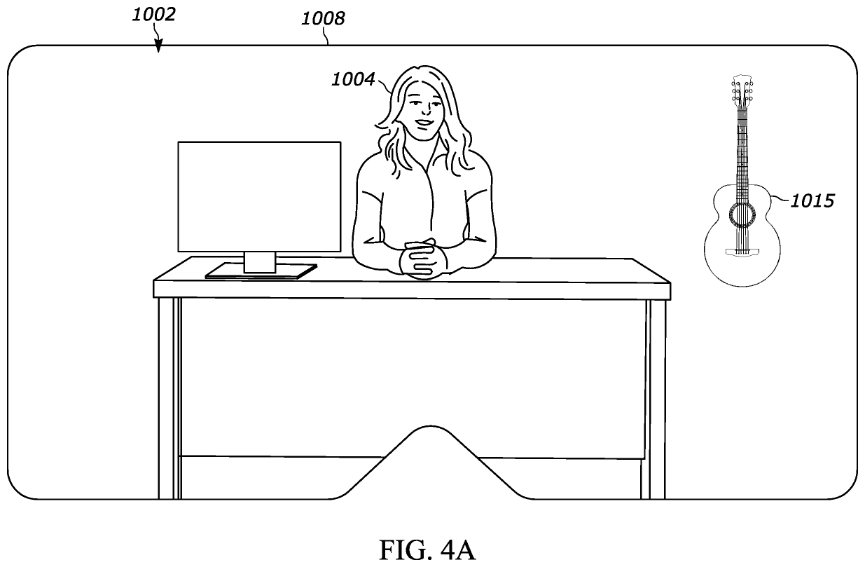

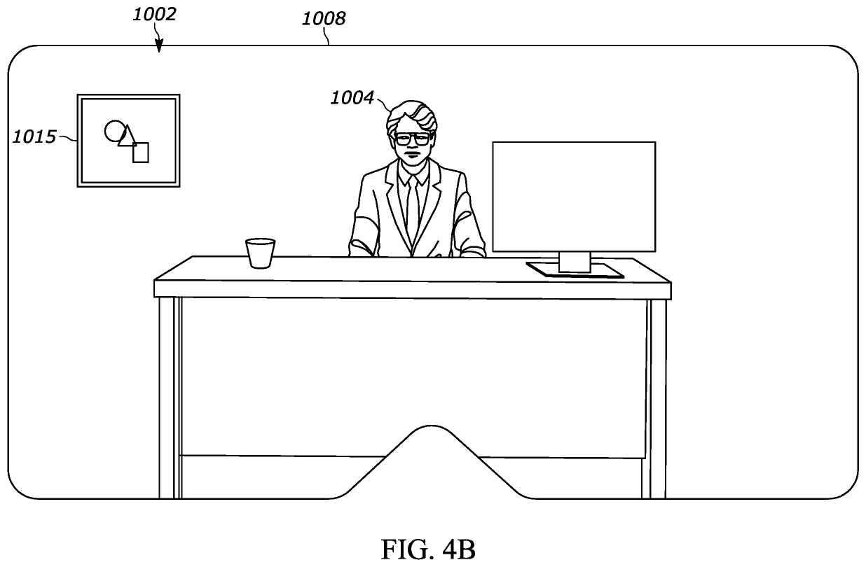

FIGS. 4A and 4B present exemplary virtual environments 1002 having synthetic representatives 1004 as provided to a user of a VR device 1008. In the current example, the VR device 1008 is a headset worn by a user. In addition to using the synthetic representative profile, the system 100 may further use images of the person to construct a three-dimensional visual representation of the person. The images may be images scraped from a social media account associated with the person.

In the illustrated examples, the synthetic representative 1004 of FIG. 4A is visually presented as a woman with about shoulder length hair that is smiling with her hands clasped resting on top of a desk. In FIG. 4B the synthetic representative is visually depicted as a man with short hair, and closed mouth smile, and his arms behind the desk.

Additionally, the virtual environment may visually present various objects and may include accent items 1015 that are indicative of an interest or a hobby of the person. For examples, in FIG. 4A the virtual environment includes a guitar as an accent item 1015, whereas a piece of art is the accent item 1015 in FIG. 4B. While illustrated in FIGS. 4A and 4B as sitting behind a desk, the synthetic representative 1004 may be visually presented as standing, sitting, kneeling, sitting on a floor or other surface, standing behind a kiosk, walking, or may be presented visually in another physical stance or position.

In some examples, the synthetic representative may be generated from personal data associated with an insurance agent, and, therefore, the synthetic representative is a synthetic agent that is representative of the physical real-world insurance agent in the virtual environment. As such, the synthetic representative profile is an insurance agent profile. In other examples, the synthetic representative may be generated from personal data associated with a customer, and, therefore, the synthetic representative is a synthetic customer that is representative of the physical real-world customer in the virtual environment. As such, the synthetic representative profile may be or represent a customer profile.

### Exemplary Method of Generating Personalized Virtual Content

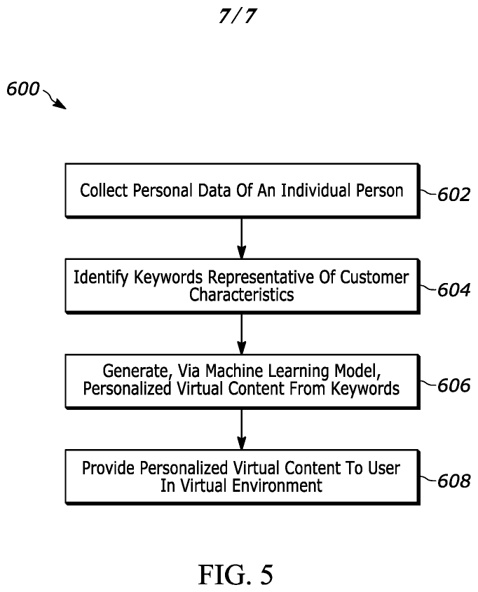

FIG. 5 illustrates an exemplary computer-implemented method 600 for generating personalized virtual content for a user in a virtual environment. The user may be any person or individual for example, the user may be a customer requesting quotes on services or insurance products, the user may be an insurance agent trainee who is to receive training in a virtual environment, the user may be a trainer to provide training in a virtual environment, or the user may be another individual with different purposes for the personalized virtual content.

The method 600 may be implemented, for example, via computing elements of the virtual experience system 100 and/or the virtual experience interface device 200 depicted in FIGS. 1 and 2 (e.g., via one or more processors executing non-transitory computer-executable instructions stored via one or more non-transitory computer-readable memories). In some embodiments, one or more computer-readable media may store non-transitory computer-executable instructions that, when executed via one or more processors, cause one or more computing devices to perform actions of the method 600. The method 600 may include additional, fewer, and/or alternate actions to those described herein, in some embodiments.

The method 600 may include collecting, via one or more processors and/or associated transceivers, personal data of a user of a virtual experience system or interface device (602). In examples, the virtual experience interface device may include a virtual headset worn by the user. The server 140 may scrape one or more social media accounts to collect the personal data (e.g., social media posts, voice recordings, photographs, images, videos, demographic data, education history, birth date, etc.) associated with the user. In some examples, the user may log into a personalized user account and the virtual headset may collect the data from the user account. The personal data may include one or more of health data, biometric data, ethnic data, race data, age, sex, gender, income bracket, credit score, personal training history, data associated with indications of knowledge of the customer, personalized multimodal learning data, or user specific required training. Further, the personal data may be data indicative of past communications of the customer with other individuals, with a social media page (e.g., posts by the user, tweets, etc.), with an agent, etc.

In various scenarios, the user may have different goals or uses for the virtual experience system 100 and therefore, the personalized content generated by the method 600 may change based upon the type of user. For example, the user may be a customer that wants to inquire about various insurances policies and products. Therefore, the personalized virtual content may include information about insurance plans that are personalized for the customer based upon the personal data (e.g., a credit score, user age, geographic location, etc.). Additionally, the customer may present a question via an input of the virtual experience interface device 200 and the personalized content may be based upon the inquiry presented by the user. In another example, the user may be an insurance agent that is to be provided training by the virtual experience system 100. As such, the personal data may include a training history, previous training evaluations and scores, the trainees goals, required training modules, etc.

The method 600 may include, via one or more processors, identifying a set of keywords representative of customer characteristics from the personal data (604). The keywords may include words and terms indicative of demographics of a person including without limitation geographical region (e.g., Florida, Southeast, U.S., etc.), age, age group, generation (e.g., Gen Z, Millennial, etc.), ethnicity, etc. The keywords may be indicative of a role or goals of the user such as if the person is a customer, an insurance agent, a trainer, a trainee, or another person that may use the virtual experience system 100. The keywords may be grouped to generate a profile for the user which may be saved into non-transitory media. The profile may also be a session profile that is used solely for a current virtual experience session of the virtual experience system 100. For example, the profile may be generated for a specific training module provided by the virtual experience system 100, and a new profile may be generated in other virtual sessions as desired.

The method 600 may include, via one or more processors, generating personalized virtual content from the set of keywords representative of the customer characteristics (606). To generate the personalized content, one or more processors of the virtual experience system 100 may employ a machine learning method, or artificial intelligence algorithm to generate the virtual content. For example, the artificial intelligence (AI) and/or machine learning method may include one or more of a neural network, regression, decision tree, clustering, reactive AI, limited memory AI, theory of mind AI, or another machine learning or AI algorithm. The machine learning may additionally be trained to generate the personalized content based upon a keyword or set of keywords directed to content messaging. For example, the machine learning model may be trained to generate personalized content pertaining to a product line, a type of insurance, products within a certain price range, products approved for a given credit score, etc., based upon a keyword or set of keywords.

The personalized virtual content may include static content (e.g., an image of an advertisement, a visual text, an interactive static menu interface, etc.) or dynamic content (e.g., a series of images that are determined based upon dynamic responses from a user, a series of environments or audio responses determined by inputs from a user, etc.). The personalized virtual content may include personalized advertising, informative content (e.g., explanations, answers to frequently asked questions, information about a product, answers to inquiries, cost for a product etc.)

In some embodiments, the set of keywords generated for the individual customers may be augmented with a predetermined set of subject-matter keywords associated with an area of interest. For example, a set of subject-matter keywords may be generated or obtained for a type of product, service, or field of information to be included in the personalized virtual content (e.g., information regarding roof damage, differences between types of life insurance, information associated with major life events, or recommendations regarding risk reduction or remedial actions for various types of risks or damage).

Such set of subject-matter keywords may be combined with the set of keywords associated with the particular individual in order to generate personalized virtual content for the particular individual with respect to an area of interest or potential interest to the user. Additionally or alternatively, such set of subject-matter keywords may be manually selected by an agent or other professional for the particular individual, or the set of subject-matter keywords may be automatically selected using an additional machine learning model or ruleset based upon collected data regarding the particular individual (e.g., data entered by a user to indicate a major life event or change in circumstances, a search string entered by a user, or metadata regarding user interaction with information in a virtual or other electronic environment).

In further embodiments, a user may select a subject matter area or question from a selection of frequently asked questions, each such selectable option being associated with a predetermined set of subject-matter keywords. In various embodiments, the personalized set of keywords associated with the particular individual may be either combined with the set of subject-matter keywords or separately provided to the machine learning model to generate the personalized virtual content for the particular individual.

The personalized virtual content may be additionally generated depending upon attributes of a synthetic agent or synthetic customer. For example, the content may be generated based upon a synthetic agent that is generated from personal data of a top performing insurance agent salesperson. The personalized content may then include answers to inquiries from a customer, and the content may be further personalized using the characteristics and visual/audio characteristics of the synthetic agent. The personalized content may be a series of answers in response to a series of customer questions, with the answers being presented through audio presented by a synthetic agent, or visually through text.

The method 600 may further include, via one or more processors, training a machine learning model to generate user-specific content based upon the set of keywords representative of the customer characteristics. The method may train the machine learning model by supervised learning, unsupervised learning, reinforced learning, or by another method to train the machine learning model. The method may include providing sets of personalized data to the system 100 and providing guidance to specific keywords and/or characteristics of an individual based upon the data in the sets of personalized data. The trained machine learning model may then be employed to generate personalized virtual content based upon one or more sets of personal data. In some embodiments, feedback may be obtained from a user following provision of the personalized virtual content (e.g., by requesting user ratings of the content or by observing user actions interaction with the content), which may be used for retraining the machine learning model to improve accuracy.

The method further may include, via one or more processors, providing the personalized virtual content to the customer in a virtual environment (608). The virtual experience system 100 may present the personalized virtual content via the virtual experience interface device 200, such as a virtual headset. The virtual environment may be a virtual three-dimensional empty space for visual representations to be presented, or the virtual environment may be a specific landscape or location such as a beach, park, city, street, house, room, etc. The personalized virtual content may include one or more of a virtual object in the virtual environment, a video, an image, synthetically produced audio, or a voice recording.

In examples, the personalized user content may include responses to customer inquiries, instructive training modules, interaction training modules, or another type of personalized virtual content to provide to a user.

### Exemplary Virtual Landscape

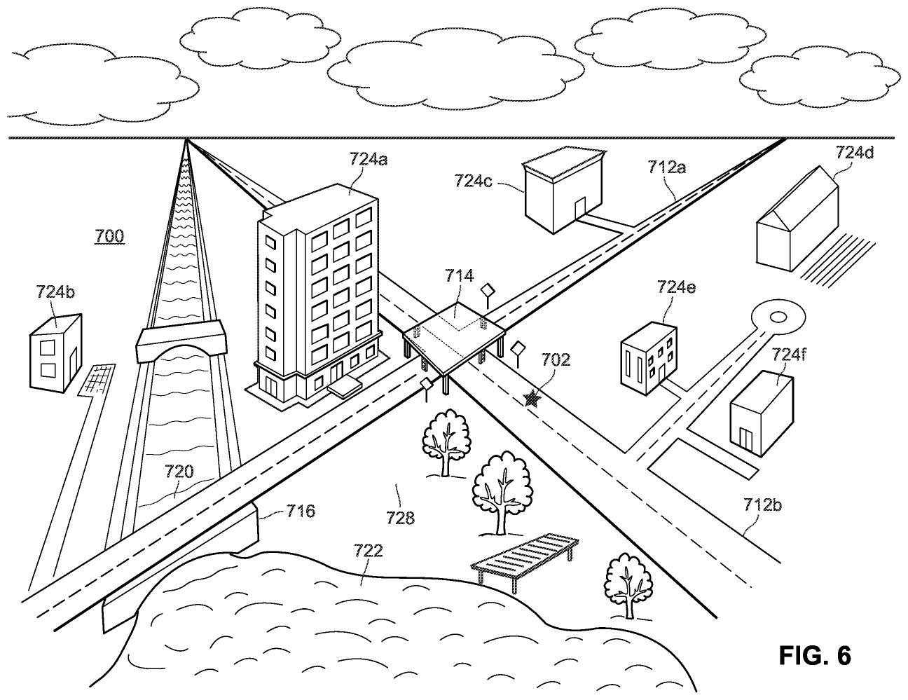

FIG. 6 illustrates an exemplary virtual landscape 700 that may be generated and provided to one or more users in a virtual environment via the techniques described herein. The virtual landscape 700 may be generated and provided via computing elements of the virtual experience system depicted in FIGS. 1 and/or 2, and/or via other suitable computing elements. The virtual landscape 700 may include additional, fewer, or alternate elements to those depicted in FIG. 6, including any components of a virtual landscape described in this detailed description.

The view of the virtual landscape 700 in FIG. 6 corresponds to just one possible view of the three-dimensional virtual space of the virtual landscape 700. While this “overhead” view is provided for clarity and ease of description, a typical view for a user in the virtual landscape may correspond to a viewing perspective (e.g., position and viewing angle) of a user 702 (also referred to herein as “user position 702”). The viewing perspective of the user 702 may vary in accordance with the user's navigation about the virtual landscape 700 using tools described herein, and thus, numerous views of the virtual landscape 700 are possible. Although a view from the perspective of the user 702 typically may be a “ground-level” view, the user 702 may, in some embodiments, move vertically about the virtual landscape 700 so as to achieve an overhead view of the virtual landscape 700 resembling the view illustrated in FIG. 6.

The layout of the virtual landscape 700 generally includes terrain upon which two major roads 712a and 712b are situated. The roads 714a and 712b intersect at an intersection 714. Various components may be present at the intersection 714, including but not limited to signs, traffic lights, vehicles, and/or utility components (e.g., power lines) providing electricity to and/or other components of the virtual landscape 700. The road 712a includes a bridge portion 716 via which the road 712a passes over a river 720. The river 720 passes under the bridge portion 716 and leads into a lake 722.

The virtual landscape 700 includes a plurality of virtual properties 724a-724f, which may include various commercial properties, residential properties, and/or other properties described herein, including combinations thereof. For example, the multi-level virtual property 724a may include a commercial property on a first floor, and other virtual commercial and/or residential properties on second, third, and fourth floors. Accordingly, any virtual property may be associated with one or more entities (e.g., property owners, renters, lessors, etc.). In some embodiments, the virtual landscape 700 may additionally or alternatively include an “undeveloped” property 728, i.e., a property upon which a structure is not yet present or fully constructed, but which may still be considered for insurability based upon one or more aspects of the virtual landscape 700.

Various characteristics of the virtual landscape 700 may be randomly generated according to the techniques described herein. For example, procedural generation techniques may be applied to determine (1) material composition of structures upon the virtual properties 724a-724f, (2) varying elevation of the terrain of the virtual landscape 700, (3) rotation, size, and/or placement of various components of the virtual landscape 700, and/or (4) meteorological elements (e.g., clouds, rain, etc.) of the virtual landscape 700.

As described herein, the virtual experience system may generate personalized virtual content for a training program to provide a user with a training module. The user may provide the virtual experience system 100 with a selection of a desired training module and the virtual experience system 100 may generated personalized content based upon the received desired training module. The system 100 may generate a virtual environment, such as the landscape 700, based upon the desired training module. The system then may determine training content based upon the personal data and the desired training module. Additionally, the system 100 may determine personalized virtual content in the form of virtual objects such as buildings, cars, rooms, landmarks, geological features, etc. based upon the determined training content.

The system 100 may then generate one or more of the determined virtual objects based upon the virtual environment, the personal data, and the determined training content. The system 100 then provides, via a virtual experience interface device 200, such as a virtual headset, the virtual environment, one or more virtual objects, and the training content to the user of the virtual experience interface device 100. In some examples, the user may interact in the virtual environment via interface hardware such as a keyboard, joystick, or other physical controller, or the user may provide inputs via a virtual user interface, motion tracking, and/or hand and gesture identification/tracking.

In the current example, generally, a training objective of the user 702 in the virtual landscape 700 is to identify one or more aspects affecting insurability of one or more virtual properties depicted therein. The user 702 may determine, for example, that a commercial property on the first floor of the virtual property 724 is associated with a business that is eligible for commercial insurance, but that is at increased risk of water-related damage in the event of flooding of the river 720. As another example, the user 702 may identify a construction material of a structure upon the virtual property 724d, to determine risk of damage to 724d (e.g., as a result of weather, natural disaster, human activity, etc.). As another example, the user 702 may identify that value (and thus, insurability) of the virtual property of the virtual property 728 may be affected by its proximity to the lake 722, even though a structure is not yet fully developed upon the virtual property 728. As will be described further herein, the virtual landscape 700 may incorporate various virtual tools that enable a user to identify one or more aspects affecting insurability of one or more virtual properties in the virtual landscape 700.

In some embodiments, a view of the user 702 in the virtual landscape 700 may comprise only a portion of the above-described components of the virtual landscape 700. In particular, due to computing limitations such as limited RAM, a view of the user 702 may be adjusted based upon computing capabilities of the device at which the virtual landscape 700 is provided. For example, when certain components of the virtual landscape 700 are outside of a limited “draw distance” of the user 702, are only in the periphery of the viewing angle of the user 702, or are obstructed by other components of the virtual landscape 700, the view of the virtual landscape 700 (1) limit graphical resolution of those certain components, (2) limit the visual detail of those certain components (e.g., by not including smaller “sub-components”), and/or (3) may omit those certain components entirely.

### Task Arrangement

In exemplary use cases in which one or more users of the virtual environment include an insurance prospecting trainee, an objective of the user may generally include identifying one or more aspects of a virtual landscape that affect insurability (e.g., risk and/or categorical eligibility) of virtual property therein and/or an entity associated therewith. To facilitate identification of aspects of a virtual landscape that affect insurability, one or more tasks may be provided to the user before entering the virtual landscape, and/or while the user is within the virtual landscape. These one or more tasks may, for example, correspond to tasks which an expert insurance prospector may be expected to perform when surveying a geographical area for potential insurance customers. The tasks may be user specific tasks that are identified based upon the personal data of the user. Additionally, the specific user dependent tasks may affect the personalized virtual content that is generated for a specific user.

Accordingly, each task may be associated with identification of zero, one, or more aspects of the virtual landscape that affect insurability. That is, completion of a task may result in positive identification of one or more aspects of the virtual landscape that affect insurability. By way of example, tasks associated with a virtual landscape may include identifying one or more virtual properties already insured by the user (e.g., based upon a mock “existing customer list” provided to the user), identifying risk due to climatological/weather effects (e.g., risk of flooding or other natural disaster); and/or estimating a monetary value of one or more virtual properties, navigating within and fully around (e.g., in a circle around) a particular virtual property to identify its structural materials or condition.

In some embodiments, a trained insurance prospector (i.e., trainer) may manually define tasks associated with a particular virtual landscape. In some embodiments, at least some tasks may be common to two or more generated virtual landscapes. In some embodiments, one or more computing elements may, upon generation of a virtual landscape, automatically generate one or more tasks to be provided to the user therein. Furthermore, in some embodiments, only a partial list of tasks may be provided to the user, where one or more hidden tasks are further expected of the user in the virtual landscape.

In some embodiments, a dedicated portion of the virtual environment (e.g., separate from the virtual landscape) may be generated and provided for arranging a task list prior to the user entering a virtual landscape. This dedicated portion of the virtual environment may represent a virtual office in which one or more users may arrange a task list for the virtual landscape, arrange relevant tools/materials for use in analyzing the virtual landscape, review relevant data relating to the virtual landscape, or perform other preparatory actions traditionally expected of an insurance prospecting specialist.

A procedurally generated virtual landscape may be associated with a number of observable aspects thereof that affect insurability of one or more virtual properties (and/or entities associated therewith). In some embodiments, upon generation of the virtual landscape, further logic may be automatically applied to determine the aspects affecting insurability based upon, (1) the presence of certain components in the virtual landscape, (2) characteristics of certain components (e.g., structural material or decay of a component of a virtual property), (3) relative arrangements of two or more components (e.g., location of a virtual property upon a flood plain), and/or other criteria described herein. Additionally or alternatively, a trained insurance prospecting specialist may enter the virtual landscape to manually identify the one or more aspects affecting insurability.

### Training Environment Interaction and Performance Evaluation

The virtual environment may implement various virtual tools such that the user may successfully identify aspects of the virtual landscape affecting insurability of a virtual property and/or entity associated therewith. Generally, use of these virtual tools by the user may cause data (i.e., user interaction data) to be transmitted to the server 140, and the server 140 may, based upon the user interaction data received at the server, (1) alter the user's view within the virtual environment, and/or (2) determine whether the user has identified an aspect of the virtual landscape affecting insurability. The successful and correct responses, as well as the incorrect responses of the trainee, may be recorded in a user profile or into personal data associated with the user. The virtual experience system 100 may access the personal data in the future to generate personalized virtual content based upon the recorded successful and incorrect responses of the user.

Virtual tools may include various tools for navigating the virtual environment. Such tools may include, for example, tools that enable a user to move (1) along roads, sidewalks, or other appropriate paths in the virtual landscape, (2) around and/or into the interior of virtual properties. In some embodiments, virtual movement tools available to a user may correspond to realistic movement in an actual physical area (e.g., in terms of movement speed and adherences to roads, doorways, etc.). Alternatively, in some embodiments, virtual movement tools may provide accelerated movement speed within the virtual landscape, and/or may provide for views of the virtual landscape that may not realistically be available to an insurance prospector in an actual physical area (e.g., the “overhead view” depicted in FIG. 6).

Virtual tools may additionally or alternatively include various user tools via which the user may actively “annotate” the virtual landscape. Such tools may include, for example, drawing tools, highlighting tools, comment tools, voice tools, etc. In some embodiments, user tools may include a camera tool and/or a recording tool, via which the user may capture still images and/or video clips that focus on particular components of the virtual landscape. Based upon a data capture command by the user, the server 140 may store an image and/or video recording of at least a portion of the virtual landscape, and may analyze the stored image and/or video to determine whether the user has identified an aspect of the virtual landscape affecting insurability. In some embodiments, use of these tools may cause additional controls, such as a drop-down tool or radio button tool, to be displayed within the virtual landscape to provide additional user interaction data regarding the captured component(s) of the virtual landscape.

In some embodiments, user tools may further enable the user to grab, collect, or otherwise manipulate particular components of the virtual landscape. In some embodiments, use of such manipulation tools may cause additional controls, such as the drop-down tool or radio button tool as described above, to be displayed within the virtual landscape to provide additional user interaction data regarding the user's observations of the manipulated component.

Virtual tools in the virtual environment may additionally or alternatively include various tracking tools, via which the server 140 may receive user interaction data to track user interaction with a virtual landscape, independently of “active” user input. These tools may, for example, include a field of view tracking tool and/or a visual focus tracking tool. The server 140 may determine, based upon received user interaction data, to which component(s) of the virtual landscape a user's attention is directed, for how long the user's attention is directed to the component(s), for what percentage of a user's session the user is positioned near or facing the component(s), etc. Based upon one or more of these determinations, the server 140 may determine whether the user has identified one or more aspects of the virtual landscape that affect insurability of one or more virtual properties and/or entities.

In some embodiments, the user may provide interaction data via additional means external to the virtual environment. For example, during or subsequent to a session in the virtual environment, the user may provide written, oral, and/or electronic responses to identify aspects of the virtual landscape that affect insurability of one or more virtual properties and/or entities.

Generally, a user's performance in the virtual environment may be evaluated based upon the user's success or failure in identifying one or more aspects of a virtual landscape affecting insurability of a virtual property and/or entity associated therewith. The user's performance may be based, for example, on (1) a total number of such aspects identified by the user and/or tasks completed in the virtual landscape, (2) a number of aspects falsely identified by the user as affecting insurability, (3) a user's identification of aspects and/or completion of tasks within a time limit, and/or other suitable criteria.

In some embodiments, a user's performance within a particular virtual landscape may be expressed as a composite score (e.g., 0 to 100). Moreover, at a higher level, the user's performance may be determined based upon evaluations of higher-level critical determinations by the user as to the insurability of a business or property depicted in the virtual landscape (e.g., eligibility for a particular insurance policy such as homeowners insurance, renters insurance, or commercial insurance). In any case, a composite score and/or other performance metrics may be used to compare performance between two or more users in a same virtual landscape, and/or to compare performance by one or more users in two or more virtual landscapes.

In some embodiments, the server 140 may store and include the composite score and/or performance metrics in personal data associated with the user/trainee, and the virtual experience system 100 may generate future personalized training, virtual environments, virtual objects, and other personalized virtual content based upon the recorded performance metrics. For example, if the server 140 determines that user performance data indicates that a particular user (or a group of users) has struggled to assess geographical components of virtual landscapes (e.g., risk posed by rain, flood, etc.), the server 140 may subsequently generate and/or provide one or more virtual landscapes having unique geographical components, so as to provide necessary training experience to those particular one or more users. Conversely, if user performance data indicates that one or more users have successfully assessed geographical components of virtual landscapes, the server 140 may subsequently generate and/or provide one or more virtual landscapes that share common geographical components (e.g., same high-level terrain layout), so as to focus user attention on other aspects of the virtual landscape in which further training is necessary.

In some embodiments, the server 140 may implement one or more of the above-described modifications by applying one or more weighting factors to an algorithm for generating components of virtual landscapes, based upon received user performance data. For example, in response to determining that users have struggled to assess risk or insurance eligibility based upon flood risks, the server 140 may apply a weighting factor to an algorithm to cause lakes, rivers, flood plains, low-lying terrain, and/or other suitable components to be more likely to be included in subsequently generated virtual landscapes, so as to provide targeted training experiences to users where appropriate.

### Shared Virtual Experience

In some embodiments, the server 140 may implement a shared virtual environment that enables two or more users to simultaneously navigate a virtual environment including a virtual landscape. To implement a shared virtual experience among two or more users, the server 140 may send data to and/or receive data from two or more virtual experience interface devices 200 via the network 130. While a two-user virtual experience is described herein, it should be understood that via these techniques, any suitable number of users may share a virtual experiences simultaneously.

In some embodiments, where two or more virtual experience interface devices 200 have differing computing capabilities (e.g., a comparatively high-capability special-purpose VR system and a comparatively low-capability, general-purpose smartphone), the server 140 may establish and maintain the shared virtual experience session by providing different data to the two or more different virtual experience interface devices 200 in accordance with their computing capabilities. For example, the server 140 may provide, to a first high-capability virtual experience interface device, a high-fidelity virtual environment, and further provide, to a second low-capability virtual experience interface device, a comparatively low-fidelity virtual environment that corresponds to the high-fidelity virtual environment, but comprises less data than the high-fidelity virtual environment. The low-fidelity virtual environment may, for example, include a lower graphical resolution, display fewer components, and/or be provided at a lower frames-per-second count in order to reduce data transmission and computing demand at the low-capability device.

In any case, to implement a shared virtual experience, the server 140 may establish one or more communication channels for substantially real-time bidirectional communication between two users. The one or more communication channels may include a text communication channel, a voice communication channel (e.g., voice-over-Internet-protocol (VOIP) channel), and/or another one or more suitable communication channels. The establishment of the one or more communication channels may enable two users to view representations of one another in the virtual environment based upon transmitted tracking data. Moreover, in some embodiments, the establishment of the one or more communication channels may enable two users to guide one another's movement and/or focus in the shared virtual environment.

In one example implementation of a shared virtual experience, the server 140 may generate a virtual landscape and provide the generated virtual landscape to a first “expert trainer” user and a second “trainee” user (e.g., via respective second virtual experience interface devices 200). Through the establishment of the shared virtual environment between the trainer and trainee users, the trainer user may observe the trainee user's navigation throughout the virtual landscape to identify aspects of the virtual landscape affecting insurability of one or more virtual properties and/or entities. In some embodiments, either or both users may be represented in the virtual environment via respective virtual avatars whose movement about the virtual environment may be controlled via input from the respective user.

In some embodiments, further virtual tools may be implemented in the shared virtual experience, via use of which the expert trainer user may improve the training experience of the trainee user. Such expert trainer tools may include, for example, a view control tool that enables the expert trainer user to control the movement and/or visual focus of the trainee user within the virtual environment. Furthermore, in a shared virtual experience, any use of suitable virtual tools by either user may be made visible to the other user in the shared environment. For example, if the expert trainer user uses an annotation tool to mark a particular component of the virtual landscape, the marking via the annotation tool may be viewable by the trainee user in a substantially real-time manner in the shared virtual environment. Thus, via use of communication channels and/or virtual tools in the shared virtual experience, two or more users may collaborate to direct each other's attention to particular components of a virtual landscape to successfully identify aspects affecting insurability of virtual properties and/or entities.

### Customer Based Personalized Virtual Content

In some embodiments, a customer may use the virtual experience system 100 to shop for products. In such cases, the virtual experience system 100 may generate personalized virtual content pertaining to a type of product, such as options or information pertaining to an insurance policy. The personalized virtual content may be generated based on data collected from a non-virtual environment such as the use of a web browser (e.g., search history, social media sites, frequently visited web pages, browsing patterns, uploaded/downloaded images or files, etc.). The personalized virtual content may provide information or advertising for financial services or information, hobbies, humor, demographic based content, personality type based content, etc. to engage a customer. In an example, the personalized virtual content may be generated based on any information indicative of a user, personality and physical characteristics of a user, user trends, user interests, or any other information pertaining to a user, with the information and data retrieved from any source.

If so desired, the customer may provide an inquiry to the virtual experience system 100 via the virtual experience interface device 200. For example, the virtual experience system 100 may generate a synthetic agent, such as in FIGS. 4A and 4B, and provide the personalized virtual synthetic agent to the customer via the virtual experience interface device 200. The customer may be presented with an office as the virtual environment, or another room for the personalized virtual content to be presented.

The synthetic agent may provide responses to the customer that provide information requested by the customer, provide answers to inquiries from the customer, provide an insurance quote to the customer, etc. In examples, the synthetic agent may provide personalized content generated based upon personal data of the customer, in other examples the synthetic agent may provide responses that have been recorded by a real live agent, and which response to provide may be determined from the personal data of the customer. In some examples, the synthetic agent may provide personalized content based upon a script associated with the synthetic agent, which may provide various responses or a basis upon which user-specific content may be generated. For example, a script comprising a plurality of responses to frequently inquiries and requests may be associated with the synthetic agent, and the responses may be used as input to generate personalized content for the customer in response to customer inquiries, such that the response information remains the same but is presented in a manner that is personalized for the customer (e.g., with customer-specific graphical elements, phrasing, or examples).

In some instances, the synthetic agent may be controlled by a real live agent that is online and the real live agent may provide verbal answers to inquiries from the customer, or interact with an interface to provide information about a product or an insurance quote to the customer, which is presented to the customer via the synthetic agent. The real live agent may control the synthetic agent using a virtual experience interface device, or the real live agent may use a desktop or other computer to control the synthetic agent to provide information to, and otherwise interact, with a customer. At times, the real live agent may not be online to control the synthetic agent. To address such instances, the synthetic agent may be configured to interact with customers without being controlled by a real live agent, such as by responding to customer inquiries and requests based upon a predefined script. As described previously, the synthetic agent may be generated based on characteristics of a real live agent, and therefore, the synthetic agent may provide information and otherwise interact with a customer based on the characteristics of the real live agent. Without being controlled by a real live agent, the synthetic agent may provide quotes, provide information about a product, answer questions, receive information from a customer, process payments, and perform other tasks and interactions with a customer. The synthetic agent may provide personalized content to the customer with, or without being operated by, or otherwise having input from, a real live agent. In some embodiments, the synthetic agent may be further configured to access a knowledge database and generate automated responses to user inquiries or requests in real time using natural language processing and machine learning algorithms. For example, the synthetic agent may be configured to parse customer queries regarding policy coverage, search knowledge databases relating to the subject matter or policy, generate a response based upon the knowledge database data, and present the response to the customer in a personalized manner.

In some embodiments, the personalized virtual content may be further generated based upon one or more characteristics of the synthetic agent. For example, the synthetic agent may be determined to present audio information with a specific dialect or vocal intonation and therefore the any response from the synthetic agent that is personalized for the user may be delivered with the determined accent or intonation. As such, the virtual experience system 100 may provide personalized virtual content to a user that is personalized based products, personal data, and user input such as inquiries and other communications.

Although described herein with reference to virtual environments, the personalized content generated for and presented to a customer may, in some embodiments, be generated and configured for presentation in static or dynamic graphical, audio, or video formats. For example, personalized virtual content may be presented to a user as a short video on a website, which the user may view on a standard display screen of a computer or mobile device.

### Additional Considerations

Although the preceding text sets forth a detailed description of numerous different embodiments, it should be understood that the legal scope of the invention is defined by the words of the claims set forth at the end of this patent. The detailed description is to be construed as exemplary only and does not describe every possible embodiment, as describing every possible embodiment would be impractical, if not impossible. One could implement numerous alternate embodiments, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain embodiments are described herein as including logic or a number of routines, subroutines, applications, or instructions. These may constitute either software (code embodied on a non-transitory, tangible machine-readable medium) or hardware. In hardware, the routines, etc., are tangible units capable of performing certain operations and may be configured or arranged in a certain manner. In exemplary embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware modules are temporarily configured (e.g., programmed), each of the hardware modules need not be configured or instantiated at any one instance in time. For example, where the hardware modules include a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example embodiments, the one or more processors or processor-implemented modules may be located in a single geographical location (e.g., within a home environment, an office environment, or a server farm). In other example embodiments, the one or more processors or processor-implemented modules may be distributed across a number of geographical locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

Some embodiments may be described using the terms “coupled,” “connected,” “communicatively connected,” or “communicatively coupled,” along with their derivatives. These terms may refer to a direct physical connection or to an indirect (physical or communication) connection. For example, some embodiments may be described using the term “coupled” to indicate that two or more elements are in direct physical or electrical contact. The term “coupled,” however, may also mean that two or more elements are not in direct contact with each other, but yet still co-operate or interact with each other. Unless expressly stated or required by the context of their use, the embodiments are not limited to direct connection.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the embodiments herein. This is done merely for convenience and to give a general sense of the description. This description, and the claims that follow, should be read to include one or at least one and the singular also includes the plural unless the context clearly indicates otherwise.

Upon reading this disclosure, those of skill in the art will appreciate still additional alternative structural and functional designs for system and a method for assigning mobile device data to a vehicle through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

The particular features, structures, or characteristics of any specific embodiment may be combined in any suitable manner and in any suitable combination with one or more other embodiments, including the use of selected features without corresponding use of other features. In addition, many modifications may be made to adapt a particular application, situation or material to the essential scope and spirit of the present invention. It is to be understood that other variations and modifications of the embodiments of the present invention described and illustrated herein are possible in light of the teachings herein and are to be considered part of the spirit and scope of the present invention.

Finally, the patent claims at the end of this patent application are not intended to be construed under 35 U.S.C. § 112(f), unless traditional means-plus-function language is expressly recited, such as “means for” or “step for” language being explicitly recited in the claims. The systems and methods described herein are directed to an improvement to computer functionality, and improve the functioning of conventional computers.

What is claimed is:

1. A computer-implemented method of generating a virtual synthetic representative, the method comprising:
collecting, by one or more processors, personal data regarding past communications of an individual person;
identifying, by the one or more processors, and from the personal data, one or more attributes indicative of personal mannerisms of the individual person;
creating, by the one or more processors, a synthetic representative profile indicative of the personal mannerisms of the person from the one or more attributes; and
virtually constructing, by the one or more processors, a synthetic representative from the synthetic representative profile, the synthetic representative including a visual representation in a virtual environment.

2. The computer-implemented method of claim 1, wherein creating the synthetic representative includes training a machine learning algorithm using the collected personal data to generate virtual representations that mimic the personal mannerisms.

3. The computer-implemented method of claim 1, wherein the personal data comprises one or more observable characteristics of the person.

4. The computer-implemented method of claim 1, wherein the personal data comprises one or more of voice recordings, photographs, images, videos, or biometric data.

5. The computer-implemented method of claim 1, wherein collecting the personal data comprises scraping data associated with a social media account.

6. The computer-implemented method of claim 5, wherein virtually constructing a synthetic representative includes generating a three dimensional avatar of the person from images associated with the social media account.

7. The computer-implemented method of claim 1, wherein the one or more attributes comprises one or more of a race, ethnicity, sex, gender, lexicon, speech pattern, intonation, physical feature, fashion style, personal interest, or hobby.

8. The computer-implemented method of claim 1, wherein the individual person comprises an insurance agent, the synthetic representative comprises a synthetic agent, and the synthetic representative profile comprises an agent profile.

9. The computer-implemented method of claim 1, wherein the individual person comprises a customer, the synthetic representative comprises a synthetic customer, and wherein the synthetic representative profile comprises a customer profile.

10. A computing system configured to generate a virtual synthetic representative, the computing system comprising:
one or more processors; and
one or more non-transitory memories storing non-transitory computer-executable instructions that, when executed via the one or more processors, cause the computing system to:
collect personal data regarding past communications of an individual person;
identify from the personal data, one or more attributes indicative of personal mannerisms of the individual person;
create, a synthetic representative profile indicative of the personal mannerisms of the person from the one or more attributes; and
virtually construct a synthetic representative from the synthetic representative profile, the synthetic representative including a visual representation in a virtual environment.

11. The computing system of claim 10, wherein to create the synthetic representative profile, the non-transitory computer-executable instructions cause the computting system to train a machine learning algorithm using the collected personal data to generate virtual representatives that mimic the personal mannerisms.

12. The computing system of claim 10, wherein the personal data comprises one or more observable characteristics of the person.

13. The computing system of claim 1, wherein the personal data comprises one or more of voice recordings, photographs, images, videos, or biometric data.

14. The computing system of claim 1, wherein to collect the personal data, the non-transitory computer-executable instructions cause the computing system to scrape data associated with a social media account.

15. The computing system of claim 14, wherein virtually constructing a synthetic representative includes generating a three dimensional avatar of the person from images associated with the social media account.

16. The computing system of claim 14, wherein the one or more attributes comprises one or more of a race, ethnicity, sex, gender, lexicon, speech pattern, intonation, physical feature, fashion style, personal interest, or hobby.

17. One or more non-transitory computer-readable media storing non-transitory computer-executable instructions that, when executed via one or more processors, cause one or more computing systems to:
collect personal data regarding past communications of an individual person;
identify from the personal data, one or more attributes indicative of personal mannerisms of the individual person;
create, a synthetic representative profile indicative of the personal mannerisms of the person from the one or more attributes; and
virtually construct a synthetic representative from the synthetic representative profile, the synthetic representative including a visual representation in a virtual environment.

18. The one or more non-transitory computer-readable media of claim 17, wherein to create the synthetic representative profile, the non-transitory computer-executable instructions, when executed, cause the one or more computing systems to train a machine learning algorithm using the collected personal data to generate virtual representatives that mimic the personal mannerisms.

19. The one or more non-transitory computer-readable media of claim 17, wherein the personal data is indicative of one or more observable characteristics of the person.

20. The one or more non-transitory computer-readable media of claim 17, wherein to collect the personal data, the non-transitory computer-executable instructions, when executed, cause the one or more computing systems to scrape data associated with a social media account.
